(19) United States
(12) Patent Application Publication
(10) Pub. No.: US 2013/0229959 A1
(43) Pub. Date: Sep. 5, 2013

(54) METHOD AND APPARATUS FOR GROUP SYNCHRONIZED CHANNEL ACCESS WITH TIM SEGMENTATION

(71) Applicants: Chittabrata Ghosh, Union City, CA (US); Klaus Franz Doppler, Albany, CA (US); Taejoon Kim, Berkeley, CA (US); Sayantan Choudhury, Berkeley, CA (US); Esa Tuomaala, Helsinki (FI)

(72) Inventors: Chittabrata Ghosh, Union City, CA (US); Klaus Franz Doppler, Albany, CA (US); Taejoon Kim, Berkeley, CA (US); Sayantan Choudhury, Berkeley, CA (US); Esa Tuomaala, Helsinki (FI)

(73) Assignee: Nokia Corporation

(21) Appl. No.: 13/523,418

(22) Filed: Jun. 14, 2012

Related U.S. Application Data
(63) Continuation-in-part of application No. 13/410,129, filed on Mar. 1, 2012.

(51) Int. Cl. H04W 52/02

(52) U.S. Cl. 370/311

(57) ABSTRACT

A method includes receiving indications of a wake-up interval assigned to a station and a corresponding group to which the station belongs, wherein all stations assigned to the group are assigned the wake-up interval. The method includes waking the station during the wake-up interval and determining, using at least the indication of the group, whether information received by the station during the wake-up interval corresponds to the group. Another method includes assigning stations to one of multiple groups based on wake-up intervals, in which stations assigned to a group all have a same wake-up interval and each group has a different wake-up interval, sending indications of a corresponding wake-up interval and a corresponding group to each of the stations, and during a interval corresponding to the wake-up interval for a selected group, transmitting the indication of the selected group and associated information meant for the group.

### CROSS-REFERENCE TO RELATED APPLICATIONS

The present application is a continuation in part of U.S. patent application Ser. No. 13/410,129, entitled “Method and Apparatus for Synchronized Channel Access Among Groups”, filed on Mar. 1, 2012, the disclosure of which is hereby incorporated by reference in its entirety. The present application is related to U.S. patent application Ser. No. 13/462,244, entitled “A Method for Efficient TIM Compression and Decoding for 802.11 ah Networks”, filed on May 2, 2012, the disclosure of which is hereby incorporated by reference in its entirety.

### TECHNICAL FIELD

This invention relates generally to wireless communications, and more specifically is directed toward different periods for channel access contention for different groups of users.

### BACKGROUND

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:
AID Association ID
AP access point (of an IEEE 802.11 network)
DCF distributed coordination function
DIFS distributed or DCF interframe spacing
DTIM delivery traffic indication map
GrPS grouping parameter set
ID identifier
IE information element
IEEE institute for electrical and electronics engineers
MAC medium access control
NAV network allocation vector
OBSS overlapping basic service set
RAW restricted access window
QoS quality of service
SB sub-block
S-DCF synchronized DCF
STA station (of an IEEE 802.11 network)
TIM traffic indication map
WLAN wireless local area network (example, IEEE 802.11)

In many wireless communication systems, devices need to compete on medium access. When the number of devices within a wireless network increases, medium access competition may lead to increased collision rate, delays, and/or power consumption. The known methods may not be sufficient in this kind of situation.

### SUMMARY

This section outlines some possible examples.

In an exemplary embodiment, an apparatus includes at least one processor and at least one memory including computer program code. The at least one memory and the computer program code are configured, with the at least one processor, to cause the apparatus to perform at least the following: receiving at a station indications of a wake-up time interval assigned to the station and a corresponding group to which the station belongs, wherein all stations assigned to the group are assigned the wake-up time interval; waking the station during the wake-up time interval; and determining, using at least the indication of the group, whether information received by the station during the wake-up time interval corresponds to the group.

Another exemplary embodiment apparatus includes means for receiving at a station indications of a wake-up time interval assigned to the station and a corresponding group to which the station belongs, wherein all stations assigned to the group are assigned the wake-up time interval; means for waking the station during the wake-up time interval; and means for determining, using at least the indication of the group, whether information received by the station during the wake-up time interval corresponds to the group.

An additional exemplary embodiment includes a method including receiving at a station indications of a wake-up time interval assigned to the station and a corresponding group to which the station belongs, wherein all stations assigned to the group are assigned the wake-up time interval; waking the station during the wake-up time interval; and determining, using at least the indication of the group, whether information received by the station during the wake-up time interval corresponds to the group.

A computer program product in one example includes a computer-readable storage medium bearing computer program code embodied therein for use with an apparatus, the computer program code comprising: code for receiving at a station indications of a wake-up time interval assigned to the station and a corresponding group to which the station belongs, wherein all stations assigned to the group are assigned the wake-up time interval; code for waking the station during the wake-up time interval; and code for determining, using at least the indication of the group, whether information received by the station during the wake-up time interval corresponds to the group.

In a further exemplary embodiment, an apparatus includes at least one processor, and at least one memory including computer program code. The at least one memory and the computer program code is configured, with the at least one processor, to cause the apparatus to perform at least the following: assigning each of a plurality of stations to one of a plurality of groups based on wake-up time intervals for the stations and the groups, in which stations assigned to a group all have a same wake-up time interval and each group has a different wake-up time interval of a plurality of wake-up time intervals; sending indications of a corresponding wake-up time interval and a corresponding group to each of the plurality of stations; and during a time interval corresponding to the wake-up interval for a selected one of the groups, transmitting the indication of the selected group and associated information meant for the group.

An additional exemplary embodiment includes means for assigning each of a plurality of stations to one of a plurality of groups based on wake-up time intervals for the stations and the groups, in which stations assigned to a group all have a same wake-up time interval and each group has a different wake-up time interval of a plurality of wake-up time intervals; means for sending indications of a corresponding wake-up time interval and a corresponding group to each of the plurality of stations; and means, during a time interval corresponding to the wake-up interval for a selected one of the groups, for transmitting the indication of the selected group and associated information meant for the group.

In an additional exemplary embodiment, a method includes assigning each of a plurality of stations to one of a plurality of groups based on wake-up time intervals for the stations and the groups, in which stations assigned to a group all have a same wake-up time interval and each group has a different wake-up time interval of a plurality of wake-up time intervals; sending indications of a corresponding wake-up time interval and a corresponding group to each of the plurality of stations; and during a time interval corresponding to the wake-up interval for a selected one of the groups, transmitting the indication of the selected group and associated information meant for the group.

In another exemplary embodiment, a computer program product includes a computer-readable storage medium bearing computer program code embodied therein for use with an apparatus, the computer program code comprising: code for assigning each of a plurality of stations to one of a plurality of groups based on wake-up time intervals for the stations and the groups, in which stations assigned to a group all have a same wake-up time interval and each group has a different wake-up time interval of a plurality of wake-up time intervals; code for sending indications of a corresponding wake-up time interval and a corresponding group to each of the plurality of stations; and code for, during a time interval corresponding to the wake-up interval for a selected one of the groups, transmitting the indication of the selected group and associated information meant for the group.

### BRIEF DESCRIPTION OF THE DRAWINGS

FIG. 1 is a schematic overview illustrating one example of a radio environment with one AP and multiple STAs and is an exemplary environment in which these teachings may be practiced to advantage.

FIG. 2 is a timing diagram illustrating sequential radio medium access intervals according to one non-limiting example of these teachings.

FIG. 3 is a timing diagram illustrating non-sequential radio medium access intervals according to another non-limiting example of these teachings.

FIG. 4 is a logic flow diagram that illustrates from the perspective of a STA the operation of a method, and a result of execution by an apparatus of a set of computer program instructions embodied on a computer readable memory, in accordance with the exemplary embodiments of this invention.

FIG. 5 is a logic flow diagram that illustrates from the perspective of an AP the operation of a method, and a result of execution by an apparatus of a set of computer program instructions embodied on a computer readable memory, in accordance with the exemplary embodiments of this invention.

Each of FIGS. 6A and 6B is a simplified block diagram of two STAs and an AP which are exemplary devices suitable for use in practicing the exemplary embodiments of the invention.

FIG. 7 is an illustration of grouping 8 STAs in DTIM/TIM segments in a beacon interval based on their wake-up intervals.

FIG. 8 is an illustration of a typical TIM bitmap representation.

FIG. 9 illustrates hierarchical AIDS of 8 STAs based on block and sub-block indications within one page.

FIG. 10 illustrates a number of examples of page bitmaps and also the hierarchical AIDS from FIG. 9.

FIG. 11 is an example of a structure of a Group ID in a GrPS.

FIG. 12 is an example of a GrPS IE, Page Bitmap, and TIM IE in DTIM and TIM segments in a (e.g., short) beacon.

FIG. 13 is a signal diagram/flowchart illustrating exemplary signaling between an exemplary station and an access point and operations taken by the station and access point.

FIG. 14 is a flowchart illustrating TIM Bitmap access either in a DTIM or in a TIM segment.

### DETAILED DESCRIPTION

Certain of the continuing development in the IEEE 802.11 WLAN specifications include support for sensor applications such as for example smart (electrical) grid meter-to-pole sensors. There is an 802.11 ah task group that is developing new methods applicable to support a large number of stations (STAs) under a single access point (AP).

Novel features are described below of, e.g., buffered data indication proposed for delivery traffic indication map (DTIM) and TIM segmentation in compliance with uplink channel access. A method of buffered data information in DTIM and TIM segments is based on grouping with respect to wake-up intervals. That is, STAs are grouped according to wake-up intervals. Additionally, a certain bitmap, called a page bitmap herein, allows STAs to wake up for a smaller time period than without the bitmap, if there is no data for the STA. These proposals are beneficial for, e.g., Wi-Fi networks with stringent power consumption constraints. Additionally, a novel method of RAW scheduling is proposed for TIM segments appended in short beacons, which is an active topic of discussion in the 802.11ah standardization work.

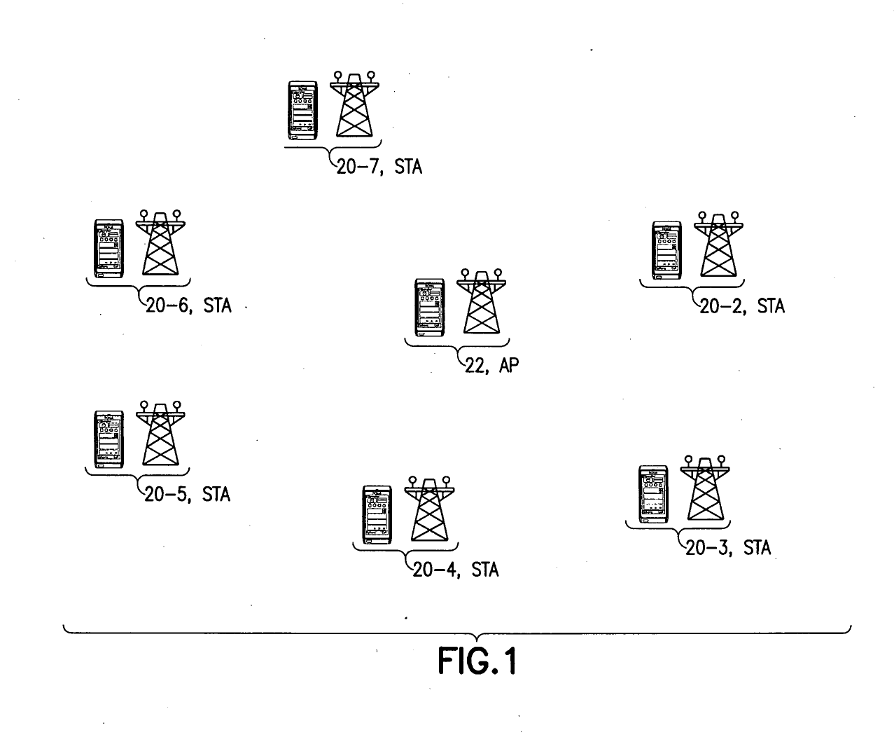

Before proceeding with additional description of the exemplary embodiments, additional description useful for understanding the exemplary embodiments is first presented. FIG. 1 illustrates an example radio environment consistent with what is envisioned for IEEE 802.11ah: a single AP 22 is serving a large number of STAs 20 (shown as 20-1 through 20-7, but one STA is generically referred to herein as 20) via wireless links, and each STA 20 is associated with an electrical power transmission or distribution line/pole for reporting sensing information to the AP 22 to enable a ‘smart-grid’. In FIG. 1 the AP 22 also is performing sensing on an electrical transmission/distribution pole with which it is associated, which in WLAN terminology makes it an AP-STA. In other relevant radio environments the AP 22 need not also be operating as a STA. Each of the other APs 20 are non-AP STAs.

In WLAN there are contention based and contention free access periods, referring to whether transmitting STAs contend for the wireless medium and are subject to collision with other STA's transmission (contention-based) or whether the STA will be transmitting on a protected radio slot in which other STAs will not be transmitting (contention-free). Relevant to some embodiments of these teachings and to ongoing development of 802.11ah is the contention-based access to which the DCF relates.

In general terms the DCF spreads in time the transmissions on the WLAN by the various STAs by requiring each STA to listen for the channel status for a DCF interframe space (DIFS) interval prior to transmitting in any contention-based period. If the channel is found busy during the DIFS interval, the listening STA defers its transmission. To avoid collisions among multiple STAs that each senses the channel is busy and each defers their access, DCF specifies an additional backoff period during which each STA will additionally wait and listen before transmitting. This reduces the likelihood of transmission collisions because the backoff period is random meaning different STAs will most likely have different backoff periods.

In current proposals to enhance the DCF to more efficiently support a large number of STAs, STAs are divided into groups based on a contention factor Q_n and a prohibition time T_n for a given n^{th} group. Each STA generates a random number r and if r<=Q_n the STA can contend for the channel, otherwise it is prohibited from doing so (and may enter a sleep mode) for the period T_n. See for example documents IEEE 802.11-11/1255r0 (September 2011 by Siyang Liu et al, CATR) and IEEE 802.11-12/0028r0 (January 2012 by Anna Pantelidou et al, Renesas Mobile Corp.).

But network traffic for the sensor scenario of IEEE 802.1 lah is anticipated to be bursty. The inventors consider that the above grouping concept might not be optimum since it is difficult to set up the Q value per group in real time, meaning there will be either congestion if the Q value is set too high or inefficient network usage if the Q value is set too low.

Below is detailed a different approach which the inventors consider more effective, a medium access control (MAC) enhancement which enables synchronized DCF contention among various groups of STAs, such as might be operating in an IEEE 802.11 ah network as one non-limiting embodiment.

In conventional WLAN there is an Association Request message/frame that the STA 20 sends to the AP 22 after authenticating. The Association Request frame carries various fields indicating the capabilities of the STA 20, including Supported Rates, QoS Capability, QoS Traffic Capability, and Power Capability.

In accordance with one non-limiting embodiment the AP 22 uses at least some of these fields to cluster the various STAs into different groups. For example, the AP 22 may base its grouping on access priority requested by the QoS STAs using the QoS Capability and QoS Traffic Capability fields. In another non-limiting embodiment the AP 22 may base its grouping of STAs on non-QoS based parameters, such as for example proximity between non-QoS STAs. The Association Request frame may carry this information to the AP 22. In one embodiment, the QoS/non-QoS information could be carried in a response message to a request received from an access node. In both of the above options, the assigned group may be indicated in some frame other than the association request.

In reply to the Association Request message the AP sends to the requesting STA 20 an Association Response frame which indicates the group ID, along with the conventional Association ID field which associates the STA 20 to the AP 22. In one non-limiting embodiment the group IDs are numbered in descending order of group priority for QoS STAs, and optionally the AP 22 bases its group ID number for the case of non-QoS STAs on their respective association times. This is how the AP 22 may determine which STAs are members of which group. Based on the Association Request frame from a new requesting STA 20, the AP either uses QoS parameters or non-QoS parameters like proximity, etc., to decide to which group the new STA is a member of. The corresponding group ID of the group to which the new STA is assigned is then sent by the AP in reply to the Association Request message. The Association Response frame indicates the group ID, along with the conventional Association ID field which associates the STA 20 to the AP 22.

In conventional WLAN there is also a beacon frame which the AP 22 transmits periodically to announce the WLAN presence. Among other things the conventional beacon frame carries a timestamp field for synchronizing the STAs, a beacon interval which tells when AP 22 is to transmit the next beacon, and capability information which advertises the capability of the AP 22 and of the network (including support for polling and encryption).

In accordance with one non-limiting embodiment of these teachings there is added to the beacon frame a new information element which is termed herein a Grouping Parameter Set (GrPS) information element. There may be other formats for delivering such an information element. In one embodiment this information may be delivered in measurement pilot frames, in addition to or instead of beacon frames. This information element informs the STAs within a group of specific ID about the time till they need to sleep before they can contend for the medium and also their medium access duration. In this non-limiting embodiment the GrPS element shall include: 1) the group ID; 2) the prohibition factor; and 3) the group interval end time. Since this GrPS information element is carried in the beacon frame the grouping is dynamic; in the extreme the AP 22 may place a given STA 20 in one group in one beacon frame and move that STA 20 to another group in a next consecutive beacon frame.

This GrPS element shall be replicated for all possible active groups at any instant. In other words, this GrPS element indicates the group ID, the prohibition factor T_n for the specific group ID set by the AP 22. Since grouping is in one embodiment based on requested access priorities, access to the radio medium in the contention period is also prioritized (from high to low priority) sequentially for this embodiment. But note it is elsewhere detailed herein that grouping may be based on non-QoS parameters such as proximity.

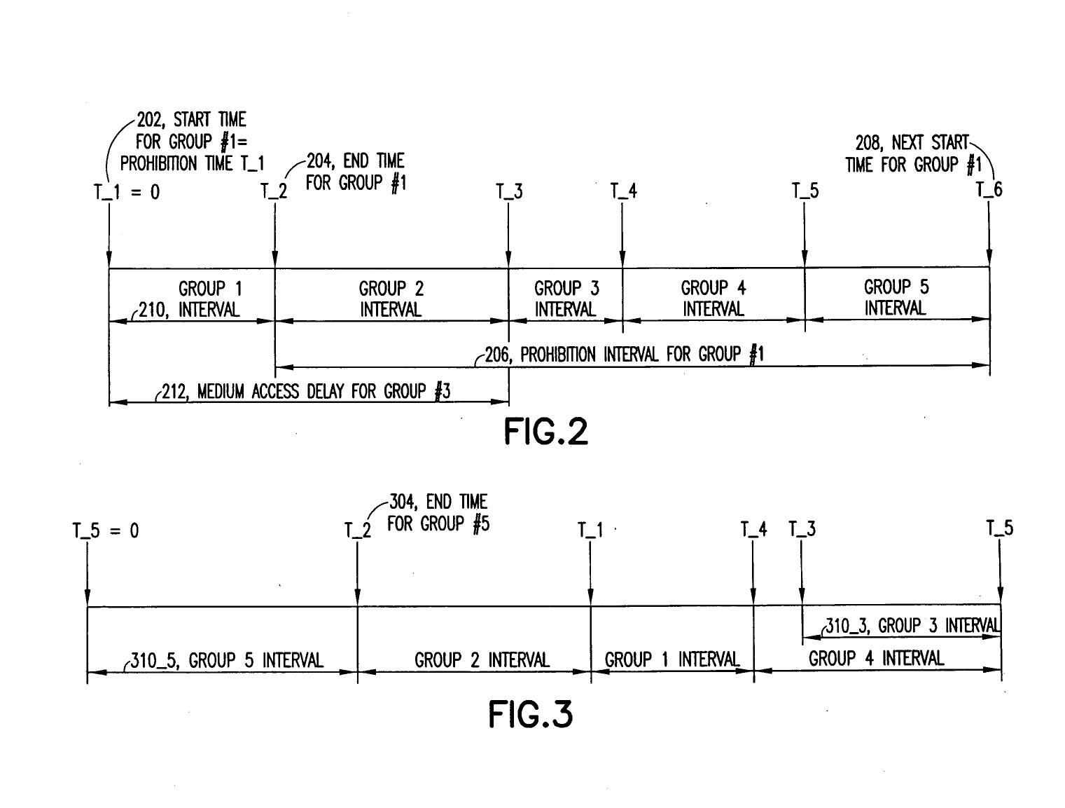

Consider the non-limiting example of group intervals at FIG. 2, assuming there are in total N=5 different groups. Among these N=5 groups, Group 1 has the highest priority and Group 5 has the lowest priority. The Group Interval End Time parameter in the relevant beacon frame indicates the end time of the radio medium access interval for all the STAs in the group identified by a specific group ID. At FIG. 2 the Group Interval End Time for group ID #1 is T_2 reference number 204. With this GrPS information element carried in the beacon frame, the contention factor Q_n noted in the background section above is no longer needed, because all the active STAs within the accessing group ID are allowed to contend simultaneously.

The Group Interval End Time fills in for what is lost by dispensing with the contention factor Q_n, but unlike Q_n which is STA-specific the Group Interval End Time applies for all STAs in the relevant group. In one non-limiting embodiment the value of the Group Interval End Time is a function of the number of associated nodes/STAs in one group. But note that neither the group members nor STAs from other groups need to know how many members are in that group. At minimum only the two parameters Prohibition Factor T_n and Group Interval End Time are needed to inform the STAs in a group about the channel access initiation time (T_{—}1=0 at FIG. 2 for group #1, reference number 202) and the end times (reference #204 for group #1 at FIG. 2). The prohibition interval 206 which terminates for a given group at that group's prohibition factor T_n gives the interval from the group's end time 204 to its next start time 208 at which members of the group are allowed to contend for the radio medium. The interval 206 for group #1 at FIG. 2 assumes the next start time for group #1 is T_6 (reference number 208), which is the same as the end time for group #5 in that non-limiting example. If we assume that there was a preceding group #5 interval immediately prior to the group #1 interval 210 that is illustrated at FIG. 2, then the prohibition interval for group #5 would run from T_1 (which is the end time of that preceding group #5 interval that is not illustrated) until T_5 (which is the start time/prohibition time for the group #5 interval that is illustrated).

In one non-limiting embodiments the length of the group medium access interval 210 (between start time 202 and end time 204) is determined by the AP 22 at least in part by the priority of the group. For example, the AP 22 may form the groups, or at least some of them, by clustering STAs with similar QoS Capability and/or similar QoS Traffic Capability fields into a same group.

From the example at FIG. 2 it can be seen that these teachings enable STAs from all the other N−1 groups to sleep during the channel access period of one specific group out of N groups, so for example all members of group #s 2 through 5 can sleep during the group#1 medium access interval 210.

Even without such a large number of STAs as contemplated by IEEE 802.11ah, from time to time there will be a STA 20 which misses a transmitted beacon frame. In this case, according to a non-limiting embodiment of these teachings that STA 20 may wait until the short beacon in order to learn its GrPS information element. The short beacon contemplated for 802.11ah is sent more frequently than the (regular) beacon. In this case the AP 22 shall include in the short beacon frame all of those group IDs whose Prohibition Times are scheduled between the beacon frame and short beacon frame transmission.

FIG. 2 makes clear that the AP 22 can schedule sequential access of the medium by several groups based on their group IDs, which are set by the AP 22 based on group priorities in this example. Based on that group's medium access priority, STAs in group #1 which has in this example the highest access priority will have the shortest prohibition time 206 and group #5 will have the largest prohibition time. In this non-limiting example the prohibition time T_i for group i may be computed per equation [1] as follows:

T_{—}i=T_(i−1)+k₍ᵢ₋₁₎*T_{—}p, i>=2 [1]

where k₍ᵢ₋₁₎ is a function of number of associated nodes/STAs in the previous group (i−1), and T_p is a constant maximum time defined by the AP 22 for Prohibition Time. An example of T_p may be the period between the beacon and short beacon, e.g., 20 ms. Here, T_{—}=0, i.e., the first assigned group, has immediate medium access and all other groups will sleep till their scheduled Prohibition Times. As an illustration of the significance of ‘k’, from FIG. 2, Group 2 has the maximum number of associated nodes and hence, prohibition time T_3, or in other words, the medium access time for Group 2 is comparatively larger among the 5 Groups.

In another non-limiting embodiment the variable k in equation [1] above is determined as a function of both the number of STAS in group i and also the priority value for group i which is assigned by the AP 22. That group priority value may in some embodiments account for the QoS parameters of the STAs that are clustered into that group, such as for example the maximum sustainable delay (medium access delay 212 shown at FIG. 2) of applications for STAs in a specific group. Considering the group priority in how the value of ‘k’ is determined allows the AP 22 to impose proportional fairness among groups of QoS STAs.

One advantage for some embodiments in which the AP 22 uses priority-based grouping is that it allows the AP 22 to impose smaller prohibition times 206 as compared to non-QoS STA groups. Smaller prohibition times (206 for group #1) result in smaller medium access delay (212 for group#3) of QoS STA groups as compared to non-QoS STA groups. After a group's initial medium access (for example, during medium access interval 210 at FIG. 2 for group #1), based on the radio medium usage by this group the AP 22 may schedule another slot for its group transmissions. So for example the AP 22 may see a high volume of data being sent by this group and maximum utilization of this assigned medium access duration. The AP interprets that there may be some STAs that did not have channel access due to maximum medium utilization. Hence, the AP may dynamically schedule that same group for another slot. On the contrary, if the AP identifies that the medium is idle during a group's medium access duration, it interprets that there are not enough active STAs in this group. Therefore, the AP reduces the medium access duration for this group in their next assigned slot. This information of the next scheduled slot is transmitted to the groups using the short beacon, which as proposed for IEEE 802.11ah will be transmitted more frequently than once per beacon period (that is, the short beacon is to be transmitted at some sub-multiple of the beacon period). In this manner the STAs in a given group need not wait until the next (full) beacon in the next beacon period for that group's next scheduled radio medium access.

These teachings also provide that the AP 22 may dynamically adjust the length of the radio medium access intervals 210, even apart from scheduling further slots as noted immediately above. For example, using the value k=1 in equation [1] above means the AP 22 is allowing that all the associated nodes for that group, regardless of whether they all have uplink data to send, will theoretically be able to access the channel for a maximum interval of time T_p.

But this is not typical and so in practice the AP 22 may instead begin with a conservative value, for example k=0.1 for each group. The value for k represents the relative amount of time, relative to the overall time shared by all groups, that a given group is allowed for medium access. So if the AP 22 chooses k=0.1 it means the AP is allowing this group 10% of the total time for the STAs in that group to transmit. If during that group's interval 210 the AP 22 observes that the radio medium is idle prior to the Group Interval End Time 204, then the AP 22 may opt to reduce the value of k by 0.05 for this same group in its next radio medium access interval. Or if instead the AP 22 observes that the duration of the interval 210 until the Group Interval End Time 204 is fully utilized by the STAs of that group, then the AP 22 may opt to raise the value of k by 0.1 for this group for that group's next channel access. By equation [1] above, the length of the prohibition time 206 depends from the value of k from the previous group, so the above example adjustments to k result in changes to the length of the radio medium access interval 210 for the group. Therefore, higher the number of associated nodes in the previous group, larger is the Prohibition Time for the next group and vice versa.

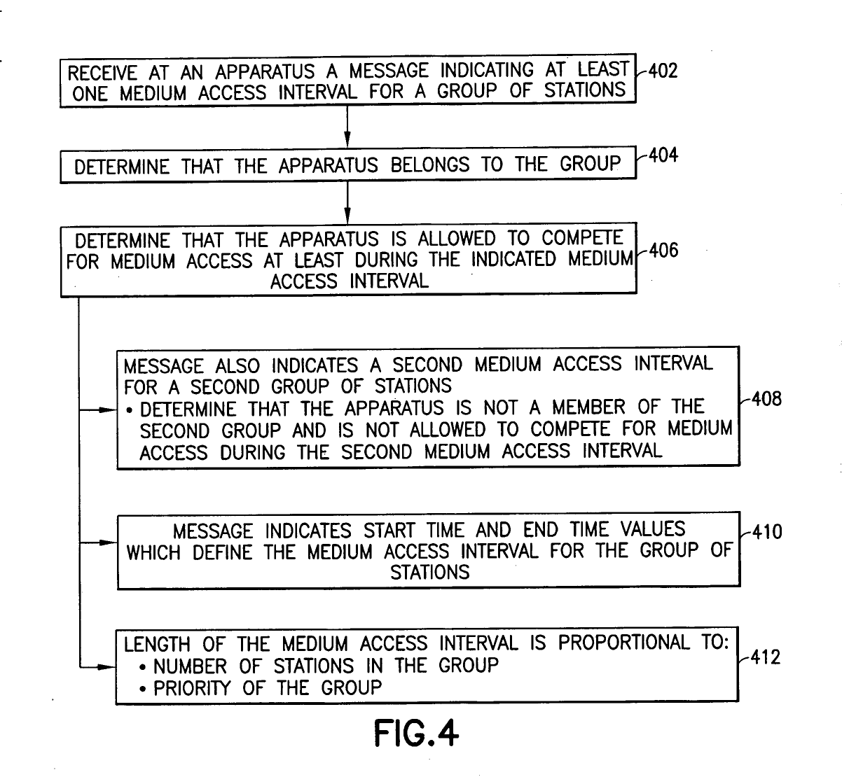

In the sequential medium access shown at FIG. 2, the Group Interval End Time of the current group is the end of the Prohibition Time T_n of the next group in the sequence. So for example at FIG. 2 the medium access interval end time 204 for group#1 coincides with the prohibition end time for group #2, which both occur at T_2. In another embodiment detailed with reference to FIG. 3 there is also the possibility the AP 22 may schedule the medium access intervals for different groups to be non-sequential.

At any point in time, the AP 22 may allow only non-QoS STAs to contend for the radio medium. In such a scenario, the AP 22 may choose to assign group IDs based on the association time of STAs within groups. This type of group ID assignment would then result in non-sequential (in terms of group IDs) medium access. As shown at FIG. 3, the AP 22 can schedule non-sequential access of the radio medium by several groups based on the number of associated STAs per group. In the example shown there, group #5 has the largest number of STA members and consequently the longest medium access interval 310_5 whereas group #3 has the least number of STA members and thus the shortest medium access interval 310_3.

In the FIG. 3 example, the prohibition time T_i for group i may be computed according to equation [2] as follows:

T_{—}i=T_(oᵢ−1)+kₒᵢ₋₁*T_{—}p [2]

where oᵢ represents the order of medium access by group i.

In non-sequential medium access of which FIG. 3 is a non-limiting example, the Group Interval End Time of the current group is the Prohibition Time T_n of the next group in the chronological order, and that chronological order is non-sequential as to group IDs. So for example the group interval end time 304 for group #5 at FIG. 3 is also the prohibition time T_2 for group #2. To avoid processing of the information at the STAs, it is useful to readily have the Group Interval End Time field in the GrPS information element. FIG. 3 also illustrates that the medium access time proportionally decreases with decreasing number of STAs per group, as in the above example in which group #5 with the highest number of STAs has a longer medium access interval 310_5 than the medium access interval 310_3 of group #3 which has the least number of STAs.

Also illustrated at FIG. 3 is that different groups may have partially overlapping medium access intervals for simultaneous medium access, shown for group #s 3 and 4. This is useful for groups with equal or nearly equal group size (for example, less than 5 STAs). This option for the AP 22 operates to reduce the medium idle time and thus wasted radio resources when a group with no active STAs contends simultaneously with one or more other groups having only a few active STAs. If there were no overlap then the radio medium would be idle and unused for the entire medium access interval of the group for which no STA were active. The AP 22 generally would not assign such a partial overlapping contention interval for groups with a large number of member STAs, since statistically it is unlikely that all of those large number of STAs will be idle across the entire medium access interval. For example, the AP 22 generally would not assign group #s 5 and 3 to contend for the radio medium simultaneously since there are a large number of STAs in group #5, but since group #4 has only a few stations the AP 22 may find it efficient to have some overlap in the medium access intervals for group #s 3 and 4.

From the above examples it is shown that by enabling a relatively long prohibition interval 206 for STAs, these teachings can result in quite a large savings of the STA's limited power supply (for the case the STAs run on a battery/fuel cell or other limited power supply). Power conservation is an important consideration in development of the IEEE 802.11ah technical standards. This power savings follows from the approaches summarized in the background section wherein the STA needs to wake-up and compare a newly generated r value against a contention factor Q_n to determine the next time it is allowed to contend for the radio medium.

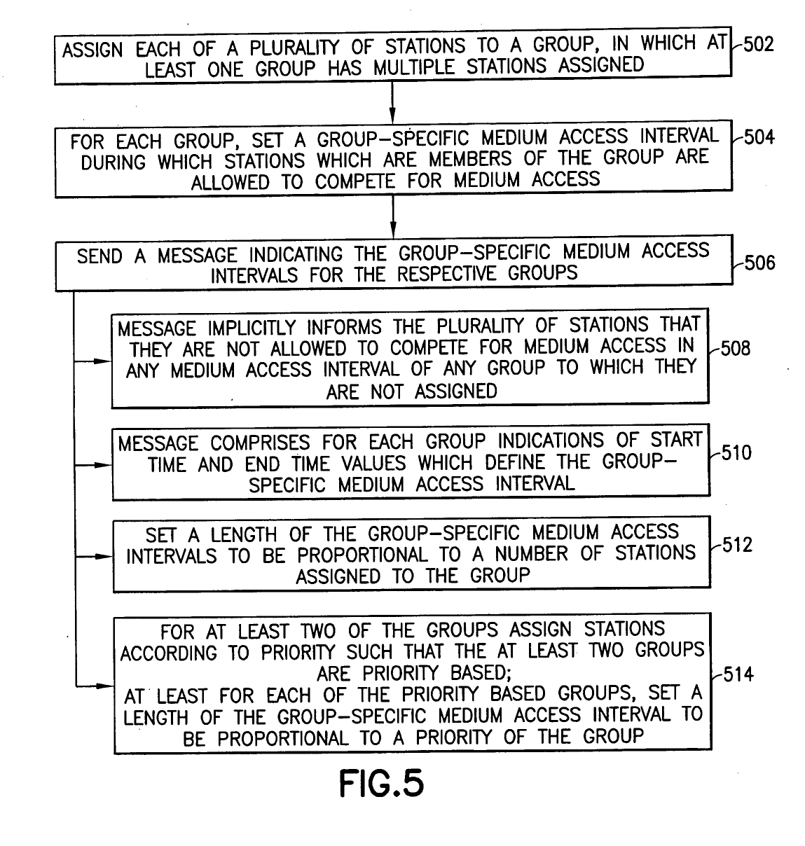

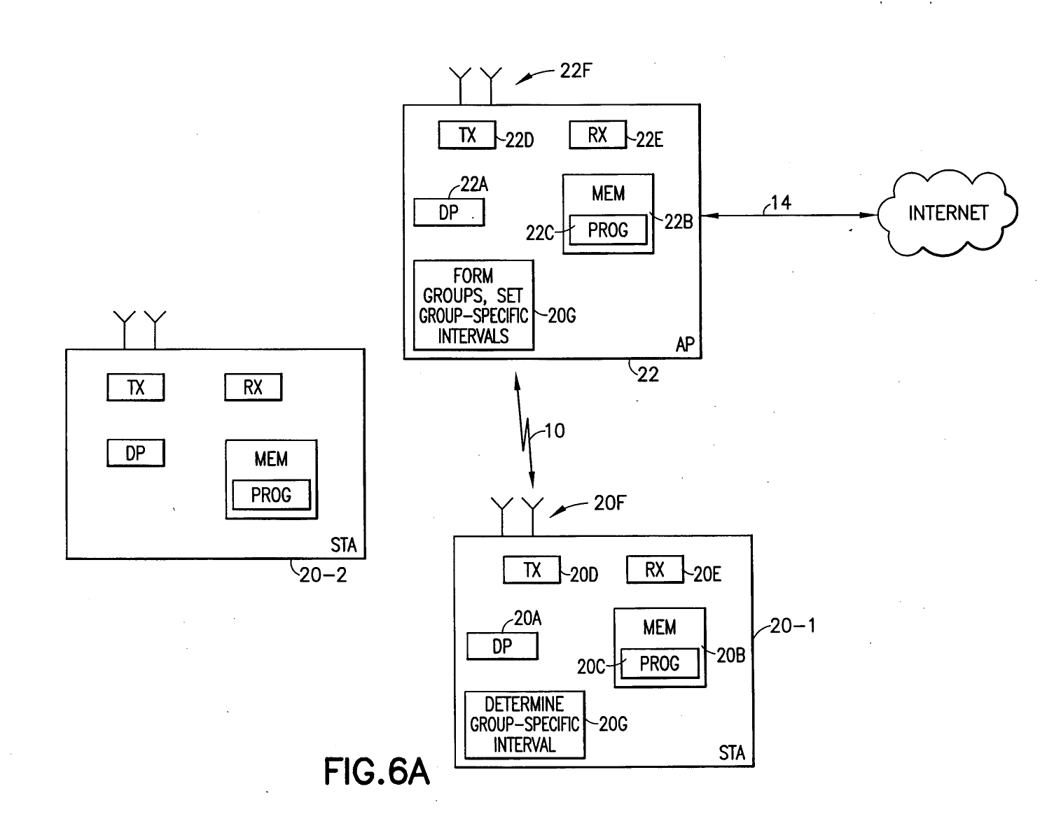

The logic flow diagrams of FIGS. 4-5 summarize some of the non-limiting and exemplary embodiments of the invention from the perspective of the STA 20 or certain components thereof if not performed by the entire STA (FIG. 4), and from the perspective of the AP 22 or certain components thereof if not performed by the entire AP (FIG. 5). These figures may each be considered to illustrate the operation of a method, and a result of execution of a computer program stored in a computer readable memory, and a specific manner in which components of an electronic device are configured to cause that electronic device to operate, whether such an electronic device is the access node in full or one or more components thereof such as a modem, chipset, or the like.

The various blocks shown at FIGS. 4-5 may also be considered as a plurality of coupled logic circuit elements constructed to carry out the associated function(s), or specific result of strings of computer program code or instructions stored in a memory. Such blocks and the functions they represent are non-limiting examples, and may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

First consider FIG. 4 which is from the perspective of the STA. At block 402 of FIG. 4 the STA 20 (or one or more components thereof) receives a message indicating a medium access interval for a group of stations. Then at block 404 the STA determines that it belongs to the group and from that it also determines at block 406 that it is allowed to compete for medium access at least during the indicated medium access interval. Note the STA does not have to compete; it may not have data to send during that medium access interval. But this is how the STA finds those intervals in which it is allowed to compete. This also differs from the approaches detailed in the background section in that the interval for accessing the wireless medium is group-wide rather than particular for individual stations. While it is possible the AP might assign only one STA to a group, for purposes of FIG. 4 assume there are at least two STAs in the group.

Further portions of FIG. 4 reflect further non-limiting details from the example embodiments above. Block 408 gives examples the STA's treatment of other group's intervals. If we consider the medium access interval of block 402 as a first medium access interval for a first group of stations, then that same message also indicates a second medium access interval for a second group of stations. The STA then determines that it is not allowed to compete for medium access during the second medium access interval, since it never determined it was a member of that second group.

Block 410 details that the message, which in the above examples is a beacon frame received by the STA 20 from an AP 22, comprises indications of start time and end time values which define the medium access interval for the group of stations that was first stated at block 402.

And finally block 412 details certain characteristics of the medium access interval of block 402, namely that the length of the medium access interval is proportional to (or more generally based at least partly on) a number of stations in the group, and/or proportional to (or more generally based at least partly on) a priority of the group of stations. But while the STA will know the length of its wireless medium access interval, it may not know how many other members are in its own group, or even whether the AP 22 used QoS priority in making priority-specific groups.

Now consider FIG. 5 which is from the perspective of the AP. At block 502 of FIG. 5 the AP 22 assigns each of a plurality of stations to a group, in which at least one group has multiple stations assigned. Typically for the 802.11ah deployment every group will have multiple stations assigned. Note also that the AP may assign each station to only a single group, or may assign one or more stations to multiple groups depending on how the AP does its grouping. Then at block 504 the AP 22, for each group, sets a group-specific medium access interval during which stations which are members of the group are allowed to compete for medium access. And then at block 506 the AP 22 sends a message indicating the group-specific medium access intervals for the respective groups.

Further portions of FIG. 5 reflect further non-limiting details from the example embodiments above. Block 508 tells that the message of block 506 implicitly informs the plurality of stations that they are not allowed to compete for medium access in any medium access interval of any group to which they are not assigned. Block 510 of FIG. 5 details that the message comprises for each group indications of start time and end time values which define the group-specific medium access interval.

Blocks 512 and 514 summarize the above examples concerning the relative lengths of those medium access intervals. Block 512 further details block 504 where the AP sets the group-specific medium access intervals. For block 512 the AP 22 does this by setting a length of the group-specific medium access intervals to be proportional to (or more generally based at least partly on) a number of stations assigned to the group (which were assigned at block 502). Block 514 gives another approach which may or may not be combined with block 512, namely that for at least two of the groups formed at block 502 stations are assigned according to priority. For convenience call these groups priority based. Then block 514 specifies that for the intervals set up at block 504 the AP, at least for each of the priority based groups, sets a length of the group-specific medium access interval to be proportional to (or more generally based at least partly on) a priority of that priority based group.

Reference is now made to FIG. 6 for illustrating a simplified block diagram of various electronic devices and apparatus that are suitable for use in practicing the exemplary embodiments of this invention. In FIG. 6 an AP 22 is adapted for communication over a wireless medium/link 10 with an apparatus, such as a mobile device/terminal or a radio-equipped sensor or a user equipment, all of which stand in the place of the AP 20 in the examples above. FIG. 6 shows only two STAs 20-1 and 20-1 but as noted above with respect to FIG. 1 there may be up to several thousand STAs served by a single AP 22. The AP 22 may be any access node (including frequency selective repeaters) of any wireless network such as WLAN in the examples above, or it may be an access node (Node B, e-Node B, base station, etc) that utilizes some other radio access technology such as for example cellular technologies LTE, LTE-A, GSM, GERAN, WCDMA, and the like which each use a contention period in their random access procedures and which may be adapted for machine-to-machine communications in which grouping according to these teachings may provide similar advantages. The various STAs may also form a cognitive radio network, with one of the cognitive radios or a node of a formal network taking on the functions detailed above for the AP. The AP 22 provides the STAs 20-1, 20-2 with connectivity to further networks via data link 14(for example, a data communications network/Internet as shown and/or a publicly switched telephone network).

One STA 20-1 is detailed below but the other STA 20-2 is functionally similar though it may be not be identical or even made by the same manufacturer. The STA 20 includes processing means such as at least one data processor (DP) 20A, and storing means such as at least one computer-readable memory (MEM) 20B storing at least one computer program (PROG) 20C or other set of executable instructions. In some embodiments the STA 20 may also include communicating means such as a transmitter TX 20D and a receiver RX 20E for bidirectional wireless communications with the AP 22 via one or more antennas 20F. If the AP 22 puts those two STAs 20-1 and 20-2 in the same group they may need to content with one another for the channel 10, but if they are not in the same group they will not contend with one another but only with other STAs assigned to their respective groups. Also stored in the MEM 20B at reference number 20G is the UE's algorithm or function or selection logic for determining its own group-specific medium access intervals from the AP's message/beacon as detailed above in various non-limiting examples.

The AP 22 may comprise processing means such as at least one data processor (DP) 22A, storing means such as at least one computer-readable memory (MEM) 22B storing at least one computer program (PROG) 22C or other set of executable instructions. The AP22 may also comprise communicating means such as a transmitter TX 22D and a receiver RX 22E for bidirectional wireless communications with the STA 20, for example via one or more antennas 22F. The AP 22 may store at block 22G the algorithm or function or selection logic for assigning STAs to groups and for setting the group-specific interval for wireless medium access as set for by non-limiting examples above.

At least one of the PROGs 22C/22G and in the AP 22, and PROGs 20C/20G in the STA 20, is assumed to include a set of program instructions that, when executed by the associated DP 22A/20A, may enable the device to operate in accordance with the exemplary embodiments of this invention, as detailed above and below. In these regards the exemplary embodiments of this invention may be implemented at least in part by computer software stored on the MEM 20B, 22B which is executable by the DP 20A of the STA 20 and/or by the DP 22A of the AP 22, or by hardware, or by a combination of tangibly stored software and hardware (and tangibly stored firmware). Electronic devices implementing these aspects of the invention need not be the entire devices as depicted at FIG. 6 but may be one or more components of same such as the above described tangibly stored software, hardware, firmware and DP, or a system on a chip SOC or an application specific integrated circuit ASIC.

In general, the various embodiments of the STA 20 can include, but are not limited to digital devices having wireless communication capabilities such as radio devices with sensors operating in a machine-to-machine type environment or personal portable radio devices such as but not limited to cellular telephones, navigation devices, laptop/palmtop/tablet computers, digital cameras and music devices, and Internet appliances.

Various embodiments of the computer readable MEMs 20B, 22B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 20A, 22A include but are not limited to general purpose computers, special purpose computers, microprocessors, digital signal processors (DSPs) and multi-core processors.

The previous description concerned certain examples. Additional examples are now described. Medium access control (MAC) with conventional distributed coordination function (DCF) may be an efficient mechanism for IEEE 802.11ah networks since this system envisions long transmission range of 1 km (one kilometer) serving over 6000 stations (STAs). The typical use case for such networks is the deployment of wireless sensors, like gas and meter sensors, as STAs that are power constrained. Conventional DCF schemes with increased number of hidden nodes may result in collisions, leading to increased number of retransmissions from such nodes and higher amount of power consumption.

For these types of systems (and other systems), a grouping concept is introduced herein such that during access by one group, all other groups are prohibited from accessing the channel. This is a version of restricted group-based medium access, and may be termed synchronized DCF (S-DCF), which is proposed to be used among STAs. This restricted access period for a group within S-DCF may also be termed as a restricted access window (RAW).

In 802.11 ah, discussions are being made to transmit only segments of TIM bitmap instead of the entire bitmap of a large number of STAs, thereby reducing the size of beacon frame, leading to short beacons. Below, novel features of, e.g., buffered data indication are proposed for delivery traffic indication map (DTIM) and TIM segmentation in compliance with the uplink channel access proposed above. The method of buffered data information in DTIM and TIM segments is based on grouping with respect to wake-up intervals. This proposal would be beneficial for Wi-Fi networks with stringent power consumption constraints. Additionally, a novel method of RAW scheduling is proposed for TIM segments appended in short beacons, which is an active topic of discussion in the 802.11ah standardization work.

By way of introduction regarding buffered data and corresponding indications, U.S. patent application Ser. No. 13/462,244, entitled “A Method for Efficient TIM Compression and Decoding for 802.11ah Networks”, filed on May 2, 2012, describes buffered data and corresponding indications as follows. “A Traffic Indication Map (TIM) is a field transmitted in beacon frames, used to inform associated wireless client devices that the access point has buffered data waiting to be transmitted to them. Access points buffer frames of data for wireless client devices while they are sleeping in a low-power state. The access point transmits beacons at a regular interval, the target beacon transmission time (TBTT). The Traffic Indication Map (TIM) information element in the periodically transmitted beacon frame, indicates which wireless client devices have buffered data waiting to be accessed in the access point. Each frame of buffered data is identified by an association identifier (AID) associated with a specific wireless client device. The AID is used to logically identify the wireless client device to which buffered frames of data are to be delivered. The traffic indication map (TIM) contains a bitmap, with each bit relating to a specific association identifier (AID). When data is buffered in the access point for a particular association identifier (AID), the bit is ‘1’. If no data is buffered, the bit for the association identifier (AID) is ‘0’. Wireless client devices must wake up and listen for the periodic beacon frames to receive the Traffic Indication Map (TIM). By examining the TIM, a wireless client device may determine if the access point has buffered data waiting for it. To retrieve the buffered data, the wireless client device may use a power-save poll (PS-Poll) frame. After transmitting the PS-Poll frame, the client mobile station may stay awake until it receives the buffered data or until the bit for its association identifier (AID) in the Traffic Indication Map (TIM) is no longer set to ‘1’, indicating that the access point has discarded the buffered data.” In the example of FIG. 6B herein, the AP 20 has buffered data 610 for one or more STAs 20. As described briefly above and in more detail below, certain exemplary techniques herein involve the AP 20 indicating the availability of the buffered data 610 in a way that provides the possibility of less power usage by STAs if the STAs do not have buffered data 610.

There is some description above about intervals (e.g., now called RAW intervals) being scheduled by the AP among various groups of STAs. However, this description may not have considered the following:

(i) The grouping mechanism, either explicitly or implicitly, prior to RAW scheduling;

(ii) A mechanism of RAW schedules partitioned within DTIM interval and over several TIM segments; and

(iii) Facilitation of efficient TIM segmentation with power saving options.

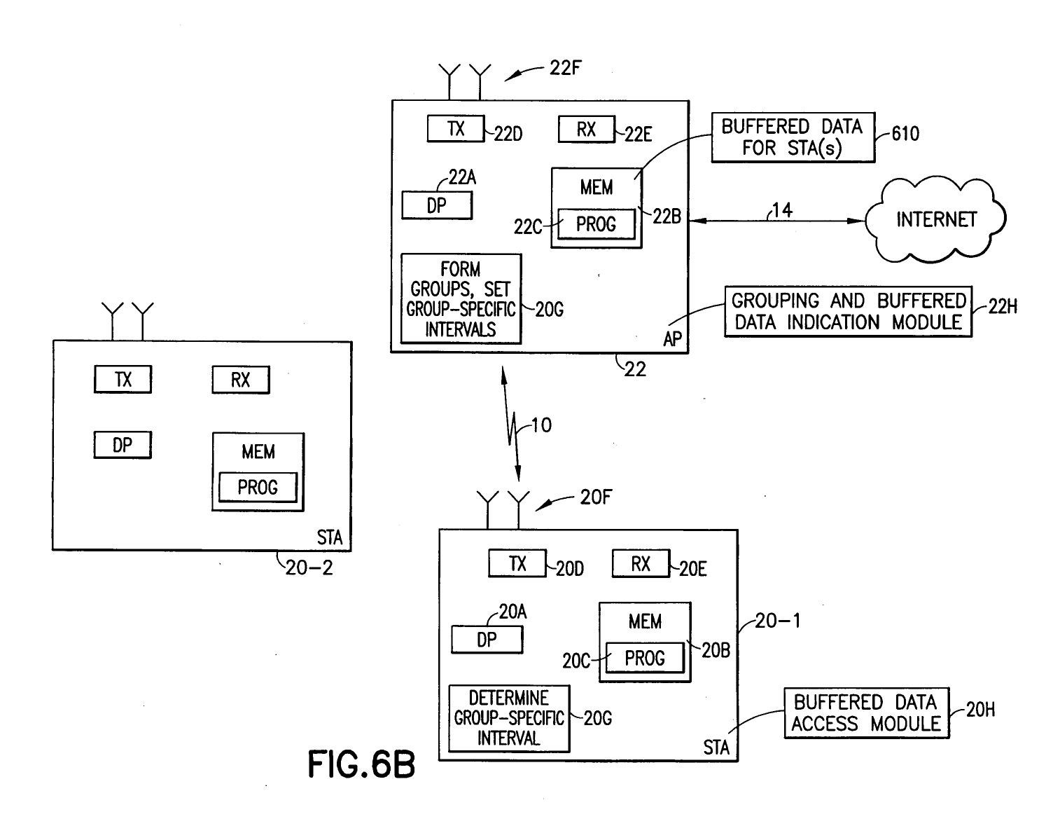

Concerning grouping among STAs in IEEE 802.11ah, STAs in an IEEE 802.11ah network may specify their wake-up interval (see IEEE 802.11-2007, section 7.3.1.6) in terms of TIM and DTIM (beacon or short beacon) intervals, or in terms of time durations, typically in ms, during an association phase using Association Request frames. It is not mandatory for such STAs to wake up at every DTIM or TIM interval, but the STAs can only wake up at their scheduled DTIM or TIM interval. Herein, it is proposed that the AP may group all STAs by negotiating a common wake-up interval. In case of a group reaching a maximum number of STAs per group, the AP may re-assign later associating STAs (but with identical wake-up intervals as STAs in this group) to another group by altering the later-associating STA's wake-up interval corresponding to STAs in that other group. This altered information on wake-up intervals is conveyed to these STAs through the Association Response frames. FIG. 7 is an illustration of grouping 8 STAs in DTIM/TIM segments in a beacon interval based on their wake-up intervals. The wake-up interval 740-1 for STA 1 20-1 in Group 2 730-2 is the DTIM segment 710, while Group 1 730-1 with STAs 2 20-2, 4 20-4, and 6 20-6 wakes up (at wake-up interval 740-2) at the first TIM segment 720-1, Group 3 with STAs 3 20-3 and 5 20-5 wakes up (at wake-up interval 740-3) in the second TIM segment 720-2, and Group 4 730-4 with STAs 7 20-7 and 8 20-8 wakes up (at wake-up interval 740-4) in the third TIM segment 720-3. There are GrPS IEs 750-1 (corresponding to DTIM segment 710) and 750-2, 750-3, and 750-4 (corresponding to TIM segments 720-1, 720-2, and 720-3, respectively), that are described in more detail below. Herein, it is proposed in an exemplary embodiment that STAs that are scheduled to wake-up at the same time interval (in terms of TIM or DTIM wake-up intervals 740) are grouped together.

Based on the grouping mechanism discussed above, some of the salient and non-limiting features of proposed exemplary embodiments include one or more of the following:

(i) A method is disclosed in which the AP may group all STAs 20 with near-valued wake-up intervals 740 by negotiating to a common wake-up interval as described above; in case of a group 730 reaching a maximum number of STAs 20 per group 730, the AP 22 may re-assign later associating STAs 20 (but with an identical wake-up interval 740 as STAs 20 in this group) to another group 730 by altering their wake-up interval 740 corresponding to STAs 20 in the other group 730.

(ii) A method is disclosed of indicating block-level buffered data 610 for DTIM and TIM segments based on corresponding scheduled groups 730;

(iii) A method is disclosed that defines a relationship between grouping and TIM bitmap either in DTIM segments 710 or in TIM segments 720;

(iv) A method of signaling group medium access in S-DCF is disclosed.

The features (i) to (iv) and any other features described herein may be implemented, e.g., using at least one of the PROGs 22C/22H and in the AP 22, and PROGs 20C/20H in the STA 20. See FIG. 6B. In FIG. 6B, the AP 22 may store at block 22H the algorithm or function or selection logic (entitled “Grouping and buffered data indication module”) for performing one or more of features (i)-(iv) described above and other features described below. The STA 20 may store at block 20H the algorithm or function or selection logic (entitled “Buffered data access module”) for performing one or more of features (i)-(iv) described above and other features described below. Note that 22H is shown separately from 22G for ease of exposition, but these may be combined (or further subdivided). Similarly, 20H is shown separately from 20G for ease of exposition, but these may be combined (or further subdivided).

Based on FIG. 7 and wake-up intervals of STAs 20, the group 730-2 in the DTIM segment 710 constitutes only STA 1 20-1, while the first TIM segment 720-1 serves a group 730-1 of three STAs namely, STAs 2 20-2, 4 20-4, and 6 20-6. The next two TIM segments 720-2 and 720-3 include two STAs per group.

Below, these exemplary methods are illustrated in detail based on the grouping mechanism on wake-up intervals 740 of STAs 20. Feature (i) has already been described above. Feature (ii), indications of buffered data 610 in DTIM/TIM segments with enhanced power save options, is now described in additional detail.

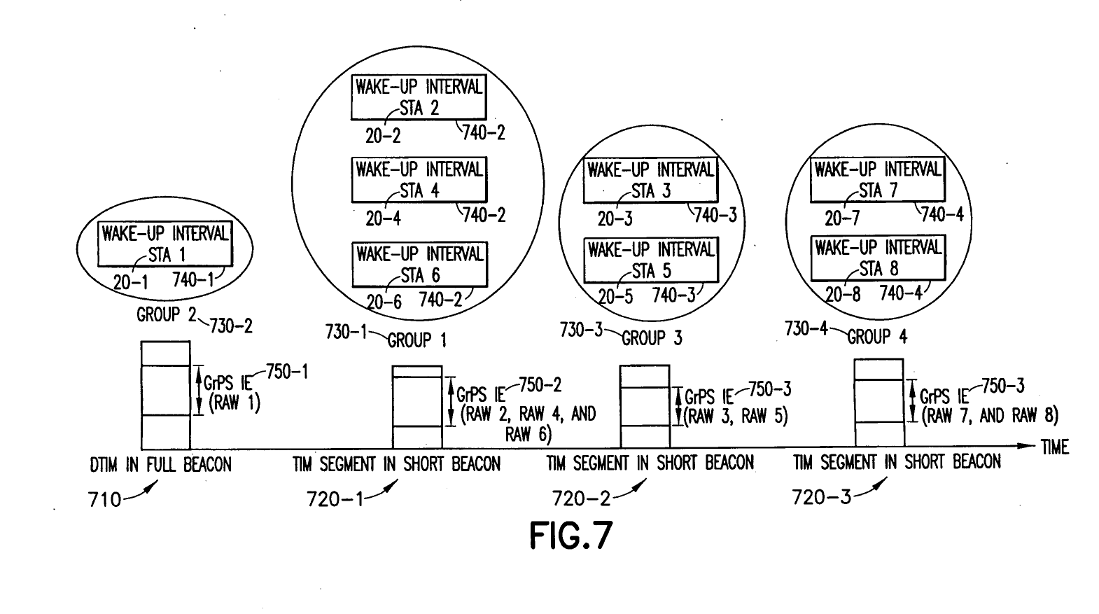

A hierarchical AID addressing is accepted in the 802.11ah Standard specification framework, with TIM Bitmap represented in terms of page, block, and sub-block bitmaps. However, such representation of TIM Bitmap may not be power efficient as will be illustrated below. A typical hierarchical TIM bitmap representation (see FIG. 8) may consist of 4 (e.g., N_{P}) pages 810-1 to 810-4, where each page 810 may consist of 32 (e.g., N_{B}) blocks 820-1 to 820-32 and with each block 820 having 8 Sub-Blocks (SB) 830-1 to 830-8. Each SB 830 corresponds to 8 STAs (that is, up to 8 STAs are assigned to a SB 830) and thus there can be correspondence to 64 STAs per block 820, 2048 STAs per page 810 and 8192 STAs per set of four blocks 810.

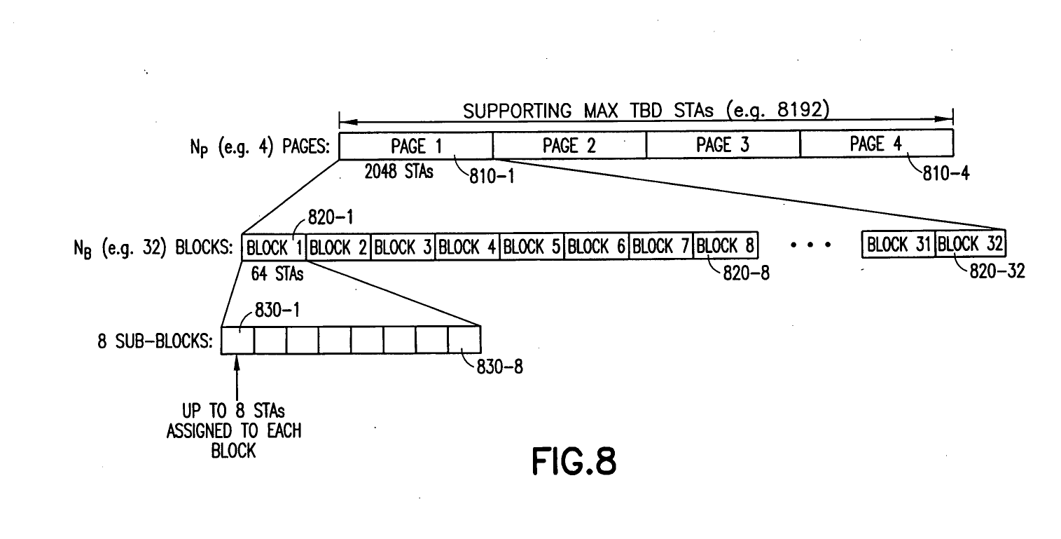

Based on the illustration in FIG. 7, the following hierarchical bitmap occurs for the 8 STAs as depicted in FIG. 9 (and using the TIM bitmap representation of FIG. 8): STA 1 20-1 is located in SB 1 830-1 and STA 8 20-8 is located in SB 8 830-8 of block 1 820-1; STA 2 20-1 is located in SB 5 830-5 of block 2 820-2; STA 4 20-4 is located in SB 2 830-2 of block 3 820-3; STA 6 20-6 is located in SB 1 830-1 of block 4 820-4; and in block 5 820-5 three STAs are located, namely, STA 3 20-3 in SB 1 830-1, STA 5 20-5 and STA 7 20-7 in SB 7 830-7.

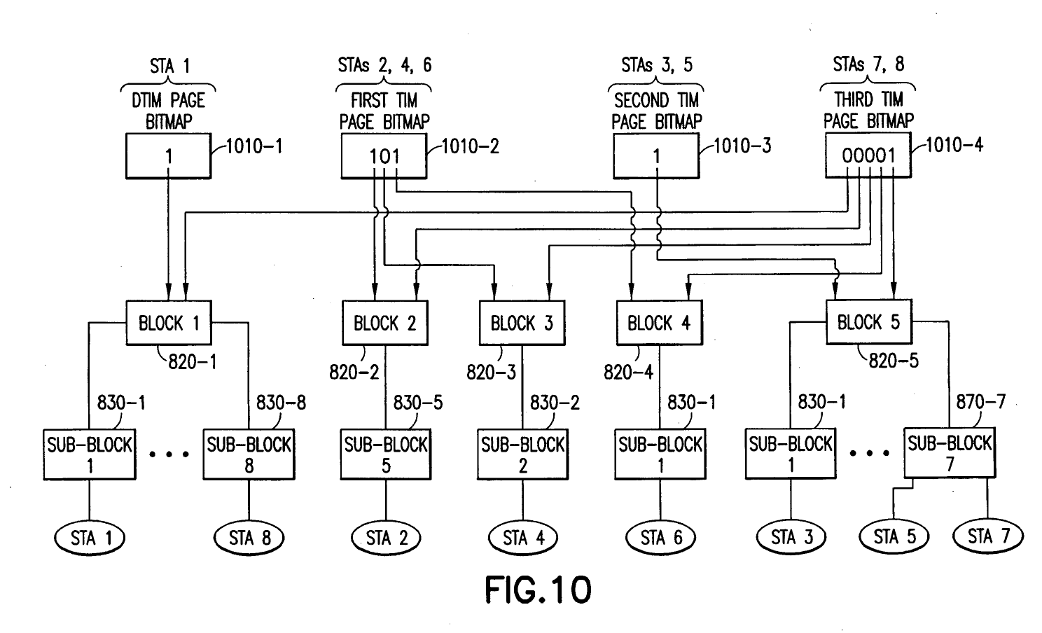

To illustrate power inefficiency of the existing TIM bitmap scheme, one may assume that STAs 4 and 8 have no buffered data 610 at the AP. Also, STAs 4 and 8 do not have any uplink data to transit to the AP. However, based on a current proposal on a TIM Bitmap, STA 4 20-4 has to wake up at the first TIM segment 720-1 and STA 8 20-8 has to wake up at the third TIM segment 720-3 to check TIM bitmaps at those segments 720 for their possible buffered data 610. Each STA has to decode two pointers: one pointer is the Block Offset (described below in reference to FIG. 11) and the second pointer is SB bitmap for each STA prior to its location. That is, using the example of STA 4 20-4 and FIG. 9, STA 4 has to decode buffered data information (i.e., indicating whether there is buffered data for a STA) corresponding to STA 1 in block 1 and SB 1, decode buffered data information corresponding STA 8 in block 1 and SB 8 and decode buffered data information corresponding STA 2 in block 2 and SB 5, and then decode the buffered data information corresponding to STA 4 in the block 3 and SB 3. Similarly, STA 8 20-8 has to decode the buffered data information corresponding to at least STA 1 in SB 1 (of block 1) prior to decoding the information in SB 8 (and block 1) corresponding to itself. If this problem is scaled, in a network with low downlink traffic, there can be hundreds of nodes in groups waking up at a common wake-up interval of either a DTIM segment 710 or a TIM segment 720 to check for buffered data 610, even if there is no buffered data 610 at the AP 22.

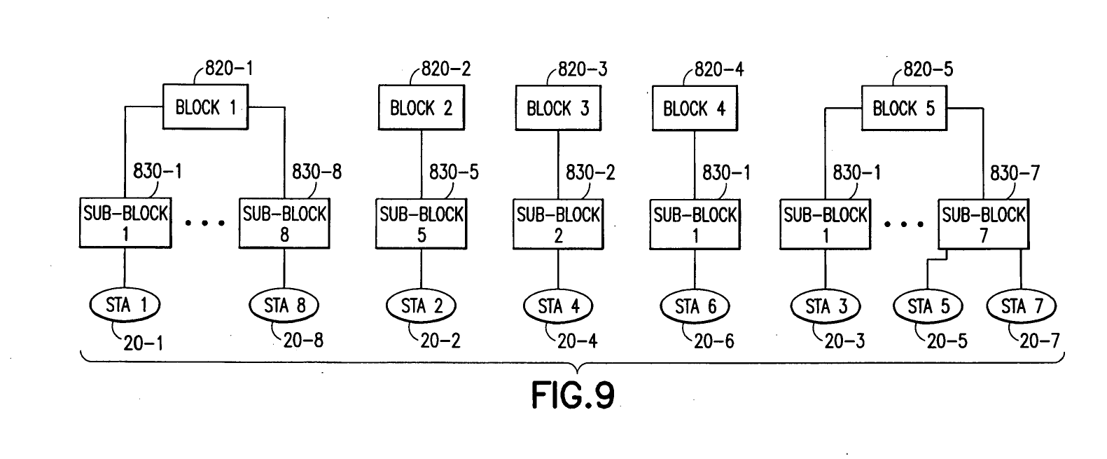

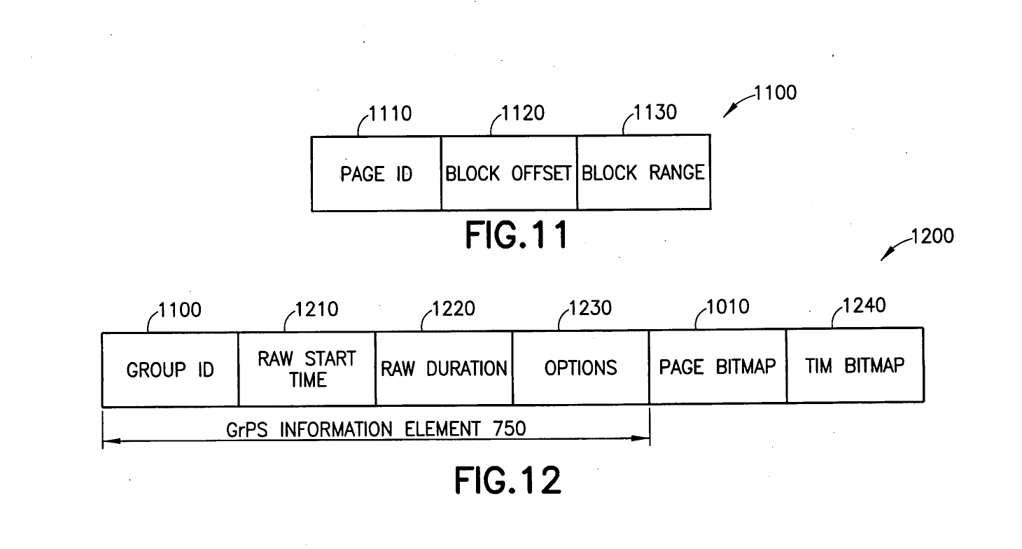

Herein, in an exemplary embodiment, a power efficient buffered data indication method is proposed for DTIM and TIM segments. A block level indication, termed a Page Bitmap (see FIGS. 10 and 12), of buffered data 610 may be appended, e.g., prior to the TIM Bitmap for assigned groups corresponding to that segment. The Page Bitmap 1010 may assist STAs in one group with no buffered data 610 not to decode two levels of pointers (as discussed above) in the entire TIM Bitmap. The STAs can go back to sleep just decoding the Page Bitmap, instead of decoding the entire TIM Bitmap (comprising, e.g., block offset, block control, block bitmap, and SB bitmaps for all the preceding blocks) until its own block.

Examples of Page Bitmaps 1010 are shown in FIG. 10. Hence, based on the Page Bitmaps 1010-2 and 1010-4 in 1st and 3rd TIM segments 720-1 and 720-4, respectively, STA 4 and STA 8 will interpret that their blocks have no buffered data 610. STA 4 may not decode the TIM Bitmap of STAs 1, 8, and 2 prior to its bitmap information and STA 8 need not decode STA 1's Bitmap prior to its bitmap information. The variable length of the page bitmap can be signaled prior to the page bitmap field. See, e.g., FIG. 11 for an example of signaling indicating the variable length of the page bitmap and see FIG. 12 for signaling of both the indication of the variable length of the page bitmap and the page bitmap (along with other elements).

In U.S. patent application Ser. No. 13/462,244, it was proposed to add the entire Page Bitmap of 32 blocks (irrespective of grouping) only in the DTIM segment, resulting in overhead of 4 bytes. Consideration of a Page Bitmap for TIM segments was not discussed there. Here, it is proposed to add a variable fraction of Page Bitmap (as shown in FIG. 10), e.g., prior to the TIM Bitmap. This fraction is a function of the number of blocks in DTIM 710 or TIM segment 720. These blocks 820, are in turn, are a function of the assigned groups 730 of STAs 20 with a common wake-up interval 740 corresponding to DTIM 710 or TIM segment 720. Hence, the Page Bitmap size is different for DTIM segment 710 and TIM segments 720 and also among TIM segments 720 based on groups 730 of STAs 20 with their wake-up intervals 740.

The Page Bitmap 1010 in DTIM/TIM shall either have a single value of the block (if only STAs 20 within a group 730 are in one block 820 and have a wake-up interval 740 corresponding to this DTIM/TIM segment as shown in DTIM Page Bitmap 1010-1 or the second TIM Page Bitmap 1010-3) or have a range of block indications (if contiguous blocks are represented in DTIM/TIM as shown in 1st TIM Page Bitmap 1010-2 or 3rd TIM Page Bitmap 1010-4). Moreover, the offset for the Page Bitmap corresponds to the Block Offset in the GrPS element and number of blocks indicated is based on the Block Range in GrPS element (detailed below).

Before proceeding with additional detail regarding features (iii) and (iv) from the list presented above, it is helpful to describe FIG. 10 in further detail. Reference should also be made to FIG.s 7, 9, and 11. First, the page bitmaps 1010-1 and 1010-3 with single ones (“1”) will be described, and then the page bitmaps 1010-2 and 1010-3 with multiple bits will be described.

In terms of the DTIM Page Bitmap 1010-1, this corresponds to STA 1 20-1, because STA 1 is in Group 2 730-2 and has a wake-up interval 740-1 in the DTIM segment 710. The only STA in the DTIM segment 710 is STA 1, so the DTIM Page Bitmap 1010-1 therefore has a single “1” to indicate the STA 1 has buffered data 610 (e.g., in Block 1 and SB 1). It is noted that if the STA 1 did not have buffered data 610, no DTIM Page Bitmap 1010-1 would be sent. (In the example of FIG. 12 below, the GrPS IE 750 may still be signaled for uplink purposes, but there would be no page bitmap.) In terms of the DTIM Page Bitmap 1010-3, this corresponds to STAs 3 20-3 and 5 20-5, because STAs 3 and 5 are in Group 3 730-3 and have a wake-up interval 740-3 in the TIM segment 720-2. Since both STAs 3 and 5 are mapped to a single block (Block 5, with STA 3 mapped to SB 1 and STA 5 mapped to SB 7), the “1” in the TIM Page Bitmap 1010-3 indicates to the STAs that they have to perform additional decoding to determine whether there is buffered data 610 for the STA. Note that one or both of the STAs 3, 5 may have buffered data 610 available.

With regard to TIM Page Bitmap 1010-2, which corresponds to STAs 2, 4, 6 in the Group 1 730-1 and the TIM segment 720-2, the data in the bitmap 1010-2 of “101” maps to contiguous blocks 820, in this case blocks 820-2, 820-3, and 820-4. The left “1” in “101” maps to block 2 820-2; the “0” in “101” maps to block 3 820-3; and the right “1” in “101” maps to block 4 820-4. Thus, STA 4 can determine based on the “0” in the page bitmap 1010-2 that the STA has no buffered data 610, and, e.g., the STA 4 can go back to sleep (e.g., without having to decode additional information). The left “1” indicates to STA 2 and the right “1” indicates to STA 6 that the respective STA has buffered data 610 and the respective STA can take additional actions to retrieve the buffered data 610.

For the TIM Page Bitmap 1010-4, this corresponds to STAs 7 and 8 in the Group 4 730-4 and the TIM segment 720-3. The data in the bitmap 1010-4 of “00001” maps to contiguous blocks 820, in this case blocks 820-1 (leftmost, first “0”), 820-2 (second “0”), 820-3 (third “0”), 820-4 (rightmost, fourth “0”), and 820-5 (“1”). The leftmost “0” indicates to STA 8, which is mapped to block 820-1, that there is no buffered data 610 for STA 8, and the STA 8 can therefore, e.g., immediately go back to sleep. The rightmost “1” indicates to STA 7, which is mapped to block 820-5, that there is buffered data 610 for STA 7, and STA 7 can therefore proceed with additional actions to retrieve the buffered data 610.

Regarding exemplary feature (iii), the relationship between grouping and DTIM/TIM segmentation, in U.S. patent application Ser. No. 13/410,129, entitled “Method and Apparatus for Synchronized Channel Access Among Groups”, it was proposed to have a GrPS information element (IE) in a beacon frame that defines the RAW schedules with RAW start and end times. Although Group IDs were mentioned, there was no formal definition of the format of those IDs.

An exemplary structure of the Group ID 1100 in the GrPS IE (see FIG. 12) is illustrated in FIG. 11. The Block Offset 1120 indicates the block 820 corresponding to the first STA index of an assigned group 730 with buffered data in that DTIM segment 710 or TIM segment 720 and block range extends to the block 820 with the last STA index. For instance, in the first TIM segment 710-1, the Group ID in the GrPS IE shall have Block 2 with STA 2 in Group 1 as the Block Offset 1120, while Block Range 1130 extends to block 4 with STA 6. Additionally, if there is only one group with all STAs included in one DTIM/TIM segment, Block Offset 1120 and Block Range 1130 values shall (in one embodiment) be the same. The Page ID 1110 identifies the page 810 to which the blocks 820 correspond.

Regarding TIM Page Bitmap 1010-2 and FIG. 10, STAs 2, 4, and 6 read block offset 1120 of the group ID 1100 of FIG. 11 to determine the offset relative to block 1 820-1 to determine to which block 820 the leftmost bit of Page Bitmap 1010-2 maps, and read the block range 1130 to determine how many contiguous blocks 820 there are. In this example, there are three contiguous blocks (Blocks 2, 3, 4) (as indicated by a value of the Block Range 1130) and a value of the Block Offset 1120 indicates the range starts at Block 2. Regarding TIM Page Bitmap 1010-4 and FIG. 10, STAs 7 and 8 read block offset 1120 of the group ID 1100 of FIG. 11 to determine the offset relative to block 1 820-1 to determine to which block 820 the left bit of Page Bitmap 1010-4 maps, and read the block range 1130 to determine how many contiguous blocks 820 there are. In this example, there are five contiguous blocks (Blocks 1-5) (as indicated by a value of the Block Range 1130) and a value of the Block Offset 1120 indicates the range starts at Block 1.

It is proposed herein, in an exemplary embodiment, that the DTIM segment 710 and TIM segments 720 indicate TIM bitmaps (via buffered data indications) for all STAs in ONLY those blocks that are indicated by the Block Range in the GrPS IE. It is evident that Block Offset and Block Ranges for DTIM and TIM segments may be different due to different groups being assigned based on varying wake-up intervals 740 of STAs 20 in different blocks.

For exemplary feature (iv), signaling RAW schedule in S-DCF, within the scheduled TIM interval, the groups of STAs that are paged may try to retrieve the downlink buffered data 610 from the AP 20. Further, all paged and unpaged STAs can utilize this interval for uplink transmissions. As a matter of fact (in the example of FIG. 7), medium access in DTIM segments is restricted to STA 1 in Group 2, while STAs 2-8 in Groups 1, 3, and 4 are prohibited from medium access during this DTIM segment. Similarly, the interval of first TIM segment 720-1 is restricted for access by STAs 2, 4, and 6 in Group 1, while being prohibited for all other groups.

Based on the above methods, it is proposed herein in an exemplary embodiment to have the elements 1200 (see FIG. 12) for RAW scheduling in each DTIM/TIM segment. Elements 1200 includes a GrPS Information Element (IE) 750, a Page Bitmap 1010, and a TIM Bitmap (e.g., IE) 1240. The GrPS IE 750 in this example includes a Group ID 1100, a RAW Start Time 1210, a RAW Duration 1220, and Options 1230. As per an exemplary proposal, the GrPS IE 750 is coupled with a TIM Bitmap IE 1240 such that the Group ID (Block Offset 1120 and Block Range 1130) field in GrPS IE is utilized by Page Bitmap 1010 and TIM Bitmap 1240 to indicate offset and the range of blocks for buffered data indication of STAs in allocated groups.

Examples of the RAW Start Time 1210 and RAW Duration 1220 fields were already described in U.S. patent application Ser. No. 13/462,244, entitled “A Method for Efficient TIM Compression and Decoding for 802.11ah Networks” to indicate to a group of STAs when they can send or receive data. Moreover, the RAW Duration 1220 field can be used for NAV (Network Allocation Vector) setting by other users in the OBSS to prevent collisions. Additionally, the Options 1230 field is proposed in the GrPS IE 750 in order to consider operations like slot-based medium access, medium access restricted to paged STAs, etc. Finally, as per an exemplary proposal, a 2-bit Page Index (proposed in current hierarchical AID addressing) in a Bitmap Control element may be no longer needed as this information is obtained from the Group ID field in GrPS IE.

An example of the TIM Bitmap 1240 is also described in U.S. patent application Ser. No. 13/462,244, entitled “A Method for Efficient TIM Compression and Decoding for 802.11ah Networks”. The TIM Bitmap 1240 includes, e.g., the indication of buffered data (in “0” for absence of data and “1” for presence) for each STA in the group. FIG. 8 herein shows the AID hierarchical addressing, which is referred to by the TIM Bitmap. In an example, the TIM Bitmap 1240 comprises a “block offset” (indicates the first block out of 32 that has buffered data), a “block bitmap” (indicates which sub-blocks in that block indicated by Block Offset has buffered data), and a SB-Bitmap (indicating which STAs in that sub-block having data. FIG. 8 herein shows the exhaustive hierarchical bitmap, and TIM Bitmap 1240 is a subset of FIG. 8.

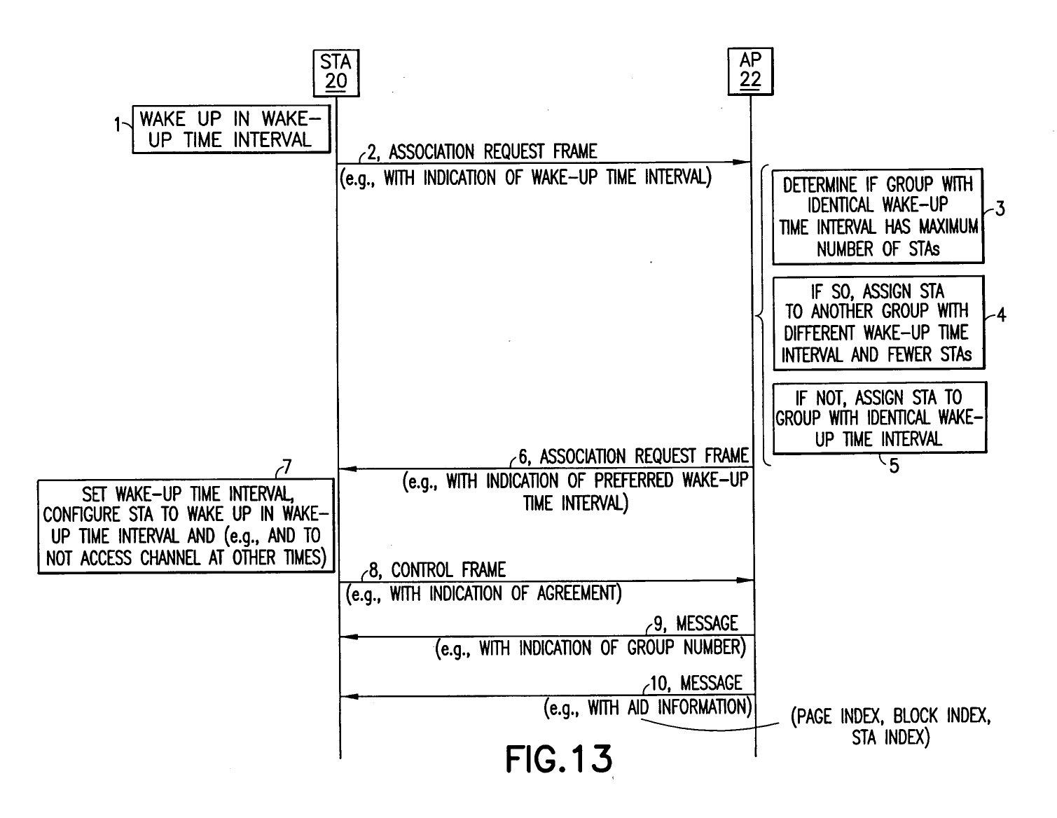

FIG. 13 is a signal diagram/flowchart illustrating exemplary signaling between an exemplary station and an access point and operations taken by the station and access point. It is noted that the sequence of operations is merely exemplary and is non-limiting. The operations may be performed, e.g., by the modules 20H and 22H in the STA 20 and AP 22, respectively. In operation 1, the STA 20 wakes up its current wake-up time interval. In operation 2, the STA 20 sends an Association Request frame to the AP 22. The Association Request frame may include an indication of the wake-up time interval currently used by the STA 20.

Responsive to the reception of the Association Request frame, the AP 220 determines (operation 3) if the group 730 with the identical wake-up time interval 740 (i.e., identical to the wake-up time interval 740 currently used by the STA 20) has the maximum number of STAs allowed for the group 730. If the group already has the maximum number of allowed STAs, in operation 4, the AP 22 assigns the STA 20 to another group 730 with a different wake-up time interval 740 and fewer STAs. For instance, the AP 22 could select the group 730 with the fewest assigned STAs or select the group 730 via some other suitable technique (e.g., a round-robin or random assignment technique). If the group does not have the maximum number of allowed STAs, in operation 5, the AP 22 assigns the STA 20 to the group 730 with the identical wake-up time interval 740.

It should be noted that the wake-up time intervals 740 are identical in the sense that these are time intervals (e.g., 20 ms) and not specific times. That is, the STAs 20 may not wake up at exactly the same specific time, but are to wake up sometime during the assigned wake-up time interval 740.

In operation 6, the AP 22 sends an Association Request frame (e.g., with an indication of a preferred wake-up time interval) to the STA 20. The preferred wake-up time interval is either the “new” group assigned in operation 4 or the current group assigned in operation 5.

Regarding the indication of the wake-up time interval, this indication may indicate a particular time duration in, e.g., a frame. In the examples presented above, the particular time duration is a time period of a D/TIM (i.e., the DTIM or TIM) segment. The indication may be “the 20th TIM segment”. For instance, in FIG. 7, the TIM segments 720-1, 720-2, and 720-3 could correspond to the 20th, 21st, and 22nd TIM segments, and “the 20th TIM segment” would therefore indicate the TIM segment 720-1. Any indication of a time duration may be used. During that time duration, the STA 20 may wake up and attempt to access the channel. At other times, the STA 20 is typically prohibited from attempting to access the channel. Thus, in operation 7, the STA 20 sets the wake-up time interval, and configures the STA 20 to wake up in the wake-up time interval and (e.g., and to not access channel at other times). In operation 8, the STA 20 sends a Control Frame, e.g., with an indication of agreement by the STA 20 to the preferred wake-up time interval.

In operation 9, the AP 22 sends a message with an indication of a group number. It is noted the indication of group number may be indicated in an Association Request frame (e.g., as illustrated in operation 6). Basically, the Group ID 1100 in the GrPS IE 750 indicates that group ID assigned to STAs during the association phase. In one example, the group number is simply a unique number assigned to each group. In this example, the group number would be sent in a D/TIM segment before the GrPS IE 750. In another example, the group number is the Group ID 1100 shown in FIGS. 11 and 12.

In operation 10, a message is signaled from the AP 22 to the STA 20. This message includes AID information. It is noted the indication of the AID information may be indicated in an Association Request (e.g., Response) frame (e.g., as illustrated in operation 6). In an example, AID information in the Association Response frame sent by the AP is related to block and SB addressing. The AID information, e.g., is a 13 bit frame, with 2 bits for page index, 5 bits to indicate one out of 32 blocks, 3 bits for sub-block index, and the last 3 bits for a STA index in a sub-block.

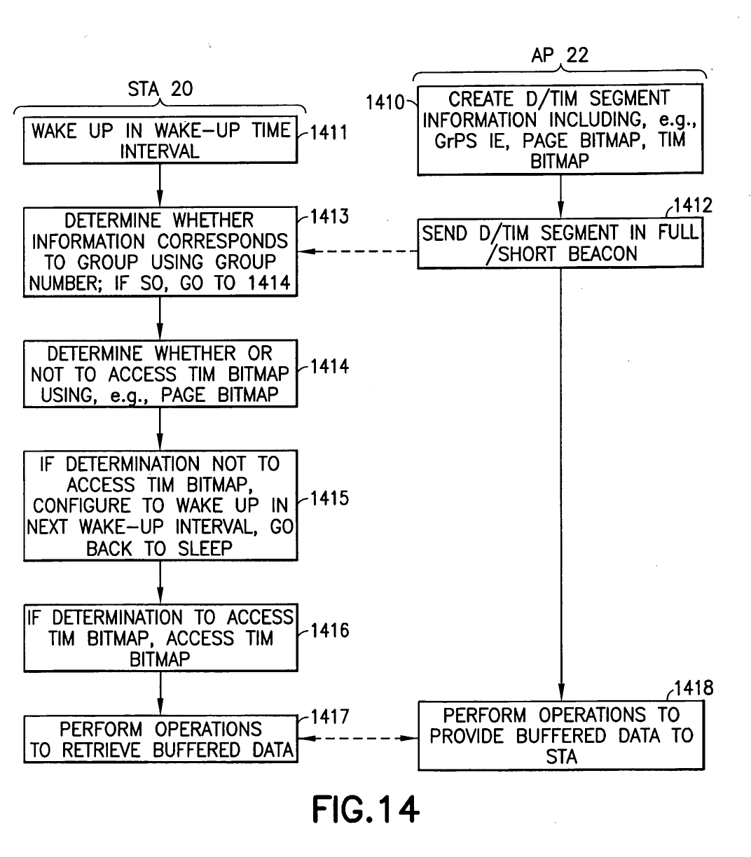

Turning to FIG. 14, this figure is a flowchart illustrating TIM Bitmap access either in a DTIM or in a TIM segment. The operations may be performed, e.g., by the modules 20H and 22H in the STA 20 and AP 22, respectively. FIG. 14, for ease of illustration, illustrates operations performed by both the STA 20 and the AP 22. In block 1410, the AP 22 creates D/TIM segment information including, e.g., the GrPS IE, Page Bitmap, TIM Bitmap, as described above. In block 1411, the STA 20 wake ups in its assigned wake-up time interval. In block 1412, the AP 22 transmits (and the STA 20 receives) a D/TIM segment in a full or short beacon.

In block 1413, the STA 20 determines whether or not to access the TIM Bitmap using, e.g., the group number and page bitmap. The group number is used by a STA 20 so that the STA 20 can determine, e.g., whether the STA 20 has woken in the correct time interval. For instance, the STA 20 will determine whether the Group ID 1100 in the example of FIG. 12 and received in this example in operation 12 is the same Group ID received in operation 9. Note that error conditions (such as the Group IDs not matching) are not addressed in FIG. 14. In block 1414, the STA 20 determines whether or not to access the TIM Bitmap using, e.g., the page bitmap 1010. In block 1415, the STA 20, if the determination from block 1414 is not to access the TIM Bitmap, configures the STA to wake up in next wake-up interval, and the STA goes back to sleep.

In block 1416, if the determination from block 1414 is to access the TIM Bitmap, the STA 20 accesses the TIM Bitmap 1240, e.g., by traversing the blocks 820 and SBs 830 as described above until the STA 20 can decode the portion of the TIM Bitmap 1240 corresponding to this particular STA. In block 1417, the STA 20 performs operations to retrieve buffered data 610 from the AP 22, and the AP 22 in corresponding block 1418 performs operations to provide the buffered data 610 to the STA 20.

It is noted that the above concerned TIM STAs, that is, STAs that operate using DTIM and TIM. However, some STAs are non-TIM STAs that are very low power devices. Therefore, the non-TIM STAs are not required to read the TIM Bitmap information to reduce power consumption, and their information are not entered in the TIM Bitmap by the AP. Regarding non-TIM STAs, the instant examples may be applied to these STAs by, e.g., the non-TIM STAs with negotiated common wake-up intervals being grouped by the AP and the group ID is informed to these STAs during the association phase. The AP reserves medium access (for uplink and downlink) for such STAs by prohibiting access to all TIM STAs. The medium access is indicated to other TIM STAs using the Group ID field in GrPS explicitly for non-TIM STAs with medium access interval indicated using RAW Start Time and RAW Duration. These explicit RAWs can be in between two intervals of RAWs for TIM STAs or after RAWs for all TIM STAs, depending upon the scheduled wake-up interval (may not be aligned to any TIM or DTIM interval).

Various modifications and adaptations to the foregoing exemplary embodiments of this invention may become apparent to those skilled in the relevant arts in view of the foregoing description. While the exemplary embodiments have been described above in the context of the WLAN and IEEE 802.11 ah system, as noted above the exemplary embodiments of this invention may be used with various other types of wireless communication systems such as for example cognitive radio systems or cellular systems as presently in use or as adapted over time in the future to handle machine to machine type communications.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

1. An apparatus, comprising:
at least one processor; and
at least one memory including computer program code;
in which the at least one memory and the computer program code are configured, with the at least one processor, to cause the apparatus to perform at least the following:
receiving at a station indications of a wake-up time interval assigned to the station and a corresponding group to which the station belongs, wherein all stations assigned to the group are assigned the wake-up time interval;
waking the station during the wake-up time interval; and
determining, using at least the indication of the group, whether information received by the station during the wake-up time interval corresponds to the group.

2. The apparatus of claim 1, wherein the information may correspond to multiple stations assigned to the group, and in which the at least one memory and the computer program code are further configured, with the at least one processor, to cause the apparatus to perform at least the following: responsive to a determination the information received by the station during the wake-up time interval corresponds to the group, determining by the station whether or not to access a bitmap in the information indicating whether buffered data is available in the access point for the station.

3. The apparatus of claim 2, wherein the bitmap is a first bitmap that is a portion of a traffic indication map hierarchically arranged into a plurality of blocks, wherein each of the blocks in the traffic indication map is hierarchically arranged into a plurality of sub-blocks, wherein one or more stations are assigned to each sub-block in the traffic indication map, and wherein determining whether or not to access the first bitmap comprises determining whether or not to access the first bitmap based on a second bitmap in the information whose size varies as a function of a number of blocks in the first bitmap, and the number of blocks in the first bitmap varies as a function of the stations assigned to the group.

4. The apparatus of claim 3, wherein determining whether or not to access the first bitmap comprises determining from the second bitmap whether a bit corresponding to a selected block, having a hierarchical connection with a sub-block assigned to the station, is a value indicating the selected block has buffered data information.

5. The apparatus of claim 4, wherein each bit in the second bitmap corresponds to a block having one or more hierarchical connections to stations assigned to the group.

6. The apparatus of claim 3, wherein the first bitmap is further hierarchically arranged into a plurality of pages, each page arranged into a plurality of the blocks, and wherein the indication of the group comprises an indication of one of the pages, a block offset indicating a first station index for the group in the first bitmap, and block range extends to a block with a last station index.

7. The apparatus of claim 6, in which the at least one memory and the computer program code are further configured, with the at least one processor, to cause the apparatus to perform: determining the size of the second bitmap using the block offset and block range, and determining to which block each bit in the second bitmap corresponds based on the block offset and block range.

8. The apparatus of claim 2, in which the at least one memory and the computer program code are further configured, with the at least one processor, to cause the apparatus to perform: accessing the bitmap indicating whether buffered data is available in the access point for the station in response to a determination by the station to access the bitmap indicating whether buffered data is available in the access point for the station.

9. The apparatus of claim 2, in which the at least one memory and the computer program code are further configured, with the at least one processor, to cause the apparatus to perform: in response to a determination by the station not to access the bitmap indicating whether buffered data is available in the access point for the station: not accessing the bitmap that indicates whether buffered data is available in the access point for the station, and causing the station to enter a sleep mode.

10. The apparatus of claim 1, wherein the wake-up time interval is a first wake-up time interval and in which the at least one memory and the computer program code are further configured, with the at least one processor, to cause the apparatus to perform:
waking up the station prior to receiving;
sending an indication of a second wake-up time interval to an access point;
receiving an indication of the first wake-up time interval from the access point; and
sending an indication of agreement for the first wake-up time interval to the access point.

11. The apparatus of claim 1, wherein the indication of the group is part of a grouping parameter set information element that is part of the information.

12. The apparatus of claim 1, wherein the wake-up interval is a traffic indication map interval and in which the at least one memory and the computer program code are further configured, with the at least one processor, to cause the apparatus to perform at least the following: not accessing a channel at times other than during the traffic indication map interval.

13. (canceled)

14. (canceled)

15. An apparatus comprising:
at least one processor; and
at least one memory including computer program code;
in which the at least one memory and the computer program code is configured, with the at least one processor, to cause the apparatus to perform at least the following:
assigning each of a plurality of stations to one of a plurality of groups based on wake-up time intervals for the stations and the groups, in which stations assigned to a group all have a same wake-up time interval and each group has a different wake-up time interval of a plurality of wake-up time intervals;
sending indications of a corresponding wake-up time interval and a corresponding group to each of the plurality of stations; and
during a time interval corresponding to the wake-up interval for a selected one of the groups, transmitting the indication of the selected group and associated information meant for the group.

16. The apparatus of claim 15, wherein the information may correspond to multiple stations assigned to the group, and wherein the information comprises a bitmap in the information indicating whether buffered data is available in the access point for the station.

17. The apparatus of claim 16, wherein the bitmap is a first bitmap that is a portion of a traffic indication map hierarchically arranged into a plurality of blocks, wherein each of the blocks in the traffic indication map is hierarchically arranged into a plurality of sub-blocks, wherein one or more stations are assigned to each sub-block in the traffic indication map, and wherein the information further comprises a second bitmap in the information whose size varies as a function of a number of blocks in the first bitmap, and the number of blocks in the first bitmap varies as a function of the stations assigned to the group.

18. The apparatus of claim 17, wherein the second bitmap comprises one or more bits, each bit corresponding to a selected block having a hierarchical connection with a sub-block assigned to a station in the group, a particular value for each bit indicating the corresponding selected block has buffered data information.

19. The apparatus of claim 17, wherein the first bitmap is further hierarchically arranged into a plurality of pages, each page arranged into a plurality of the blocks, and wherein the indication of the group comprises an indication of one of the pages, a block offset indicating a first station index for the group in the first bitmap, and block range extends to a block with a last station index.

20. The apparatus of claim 15, wherein the wake-up time interval is a first wake-up time interval and in which the at least one memory and the computer program code are further configured, with the at least one processor, to cause the apparatus to perform:
receiving an indication of a second wake-up time interval from a station;
determining there are too many stations already assigned to a group to which the second wake-up interval corresponds and assigning the station to a different group having the first wake-up interval, wherein the first and second wake-up intervals are different;
sending an indication of the first wake-up time interval from the access point to the station; and
receiving an indication of agreement for the first wake-up time interval from the station.

21. The apparatus of claim 15, wherein the indication of the group is part of a grouping parameter set information element that is part of the information.

22. The apparatus of claim 15, wherein the wake-up interval is a traffic indication map interval.

23. (canceled)

24. (canceled)
